(19) United States
(12) Patent Application Publication
(10) Pub. No.: US 2012/0203710 A1
(43) Pub. Date: Aug. 9, 2012

(54) SYSTEM AND METHOD OF MANAGING AN INVESTMENT ON BEHALF OF AN INVESTOR

(75) Inventors: Kenneth Steven RABSON, Johannesburg (ZA); Adrian Gore, Sandton (ZA); Herschel Phillip Mayers, Johannesburg (ZA)

(73) Assignee: DISCOVERY HOLDINGS LIMITED, Sandton (ZA)

(21) Appl. No.: 13/365,430

(22) Filed: Feb. 3, 2012

(30) Foreign Application Priority Data
Feb. 4, 2011 (ZA) 2011/00961

(51) Int. Cl. G06Q 40/06

(52) U.S. Cl. 705/36 R

(57) ABSTRACT

A method and a system for managing an investment on behalf of an investor includes a monitoring module to monitor the performance of an investment over a period of time, the investment being an investment managed by an investment manager on behalf of an investor. A comparator module compares the performance of the investment with the performance of other similar types of investments for the period of time and a booster module to determine an extra payment from the investment manager to the investor in the event that the performance of the investment is not as good as the performance of the other similar types of investments for the period of time. A payments module effects the extra payment from the investment manager to the investor.

### BACKGROUND OF THE INVENTION

The present invention relates to a system and method of managing an investment on behalf of an investor.

An investor often chooses an investment manager to invest funds on their behalf. In this scenario, the investor normally gives the investment manager guidelines on what type of asset class or type of fund in which they wish to invest but then relies on the investment manager to select a particular investment within that asset class or type of fund.

If the investment manager does not select the best performing fund the investor obviously loses out.

The present invention seeks to address this.

### SUMMARY OF THE INVENTION

According to one example embodiment there is provided a system for managing an investment on behalf of an investor, the system including:
a monitoring module to monitor the performance of an investment over a period of time, the investment being an investment managed by an investment manager on behalf of an investor;
a comparator module to compare the performance of the investment with the performance of other similar types of investments for the period of time;
a booster module to determine an extra payment from the investment manager to the investor in the event that the performance of the investment is not as good as the performance of the other similar types of investments for the period of time; and
a payments module to effect the extra payment from the investment manager to the investor.

According to another example embodiment there is provided a method for managing an investment on behalf of an investor, the method including:
monitoring the performance of an investment over a period of time, the investment being an investment managed by an investment manager on behalf of an investor;
comparing the performance of the investment with the performance of other similar types of investments for the period of time;
determining an extra payment from the investment manager to the investor in the event that the performance of the investment is not as good as the performance of the other similar types of investments for the period of time; and
effecting the extra payment from the investment manager to the investor.

### BRIEF DESCRIPTION OF THE DRAWINGS

FIG. 1 is a block diagram illustrating an example system to implement the methodologies described herein; and

FIG. 2 is a block diagram illustrating an example embodiment method.

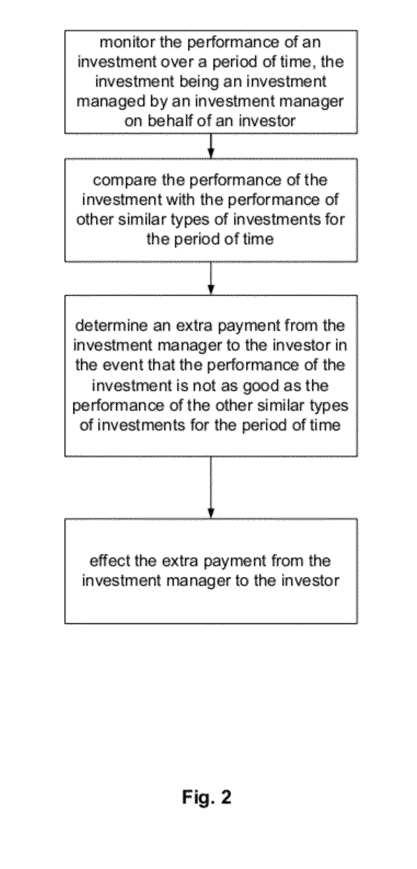

### DESCRIPTION OF EMBODIMENTS

The present invention relates to a system and method of an investment on behalf of an investor.

An investor often chooses an investment manager to invest funds on their behalf. In this scenario, the investor normally gives the investment manager guidelines on what type of asset class or type of fund in which they wish to invest but then relies on the investment manager to select a particular investment within that asset class or type of fund.

If the investment manager does not select the best performing fund the investor obviously loses out.

A system and method for addressing this is described below.

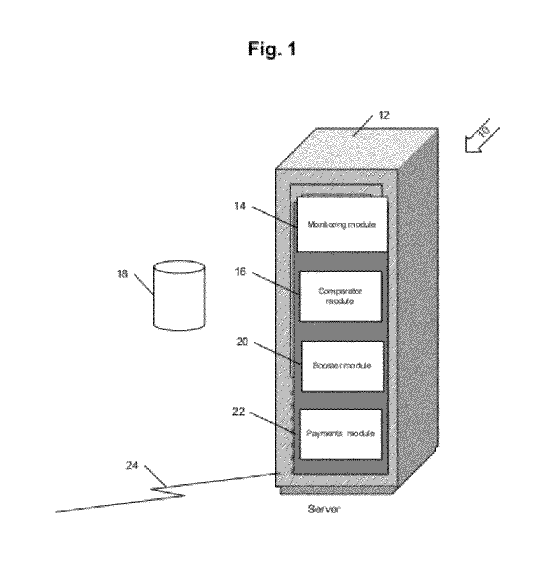

Referring to FIG. 1, an information processing system 10 may include a server 12 that includes a number of modules to implement the present invention.

In one example embodiment, the modules described below may be implemented by a machine-readable medium embodying instructions which, when executed by a machine, cause the machine to perform any of the methods described above.

In another example embodiment the modules may be implemented using firmware programmed specifically to execute the method described herein.

It will be appreciated that embodiments of the present invention are not limited to such architecture, and could equally well find application in a distributed, or peer-to-peer, architecture system. Thus the modules illustrated could be located on one or more servers operated by one or more institutions.

It will also be appreciated that in any of these cases the modules form a physical apparatus with physical modules specifically for executing the steps of the method described herein.

In the illustrated example embodiment, the server 12 includes a monitoring module 14 that monitors the performance of an investment over a period of time, the investment being an investment managed by an investment manager on behalf of an investor.

It will be appreciated that the investment could be any type of investment such as one or more of cash, bonds, stocks, property or an investment fund to name but a few examples.

For purposes of illustration, the present invention will be described with reference to the use of an investment fund.

In any event, the monitoring module 14 typically receives investment data via communications network 24 typically from a third party data provider. The network, in one embodiment, is a wide area network, local area network, wireless network, or the like. The investment data at least includes such information as unit prices, fees paid and income generated by the investment. The investment data is stored in the memory 18 for use by a comparator module 16.

The monitoring module 14 typically receives the investment data from third party investment management systems.

The comparator module 16 compares the performance of the investment fund selected by the fund manager with the performance of other similar types of investments for the period of time. This will be described in more detail below.

A booster module 20 determines an extra payment from the investment manager to the investor in the event that the performance of the investment is not as good as the performance of the other similar types of investments for the period of time.

A payments module 22 effects the extra payment from the investment manager to the investor.

The system and method implemented by the system is aimed at ensuring that the performance of the investor chosen fund is favourable relative to the other funds in their sectors.

If the chosen fund is not in the top quartile of all funds in its sector over each 5 year period from the commencement date, the investor will receive a boost to their fund's 5 year growth based on the fund's relative performance in its sector.

It will be appreciated that sector classification could be done in a number of ways. One example is for the investment manager to predefine the sector classification in an obvious manner. For example, a unit trust that invests solely in equities could be predefined to be compared with other unit trusts that invest solely in equities.

Another method of determining the sector classification is to use an industry standard. An example in South Africa is the industry body ASISA classification of sectors.

It will be appreciated that whilst the period selected is 5 years this is for illustrative purposes only and the period could be any other suitable period.

| | Boost if | Boost if | Boost if |
|---|---|---|---|
| | performance is | performance is | performance is |
| | in the bottom | in the 3^{rd} 25% | in the 2^{nd} 25% |
| Discovery | 25% of sector | of sector (3^{rd} | of sector (2^{nd} |
| Fund | (4^{th} quartile) | quartile) | quartile) |
| Discovery | 15% | 10% | 5% |
| Absolute | | | |
| Return Fund | | | |
| Discovery | | | |
| Diversified | | | |
| Income | | | |
| Fund | | | |
| Discovery | | | |
| Balanced | | | |
| Fund | | | |
| Discovery | | | |
| Global Fund | | | |
| of Funds | | | |
| Discovery | | | |
| Flexible | | | |
| Property | | | |
| Fund | | | |
| Discovery | 20% | 15% | 10% |
| Equity Fund | | | |
| Discovery | | | |
| Global | | | |
| Equity | | | |
| Feeder Fund | | | |

The funds referred to above are example funds managed by the applicant.

The boosts described above are expressed as a percentage of the initial contribution into the relevant fund.

It will also be appreciated that the percentages listed above are exemplary and could be changed to suit different market conditions and the size of the relevant funds invested.

When comparing the performance of the various funds it will also be appreciated that different methodologies could be used. The most basic methodology is simply to compare the growth in unit values of the funds over the period of time. However, at the methodologies could also be used including determining the income generated by the investment over the period of time. In the case of equities, this would entail comparing the dividends distributed for example.

In addition, whilst in the example embodiment the comparator module 16 is described as comparing the performance of the fund with the selected other funds and determining in which quartile the performance of the fund falls, this comparison could be done in other ways not using quartiles but rather using other percentages or ranking systems.

In one example, the investor must be invested in the applicable Discovery Fund for the full 5 years in order to receive the boost to their fund.

If the investor switches into a qualifying fund after the commencement date, their boost will be reduced by 20% in the first year and by an additional 20% in each year thereafter. This effectively means that if the investor is not invested in the same fund for the full five years the benefit is pro-rated.

### NON-LIMITING EXAMPLES

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

Although the various embodiments of the present invention are described in the context of a fully functional computer system, those skilled in the art will appreciate that embodiments are capable of being distributed as a program product via CD or DVD, e.g. CD, CD ROM, or other form of recordable media.

What is claimed is:

1. A computer system for managing an investment on behalf of an investor, the system including:
a monitoring module to monitor the performance of an investment over a period of time, the investment being an investment managed by an investment manager on behalf of an investor;
a comparator module to compare the performance of the investment with the performance of other similar types of investments for the period of time;
a booster module to determine an extra payment from the investment manager to the investor in the event that the performance of the investment is not as good as the performance of the other similar types of investments for the period of time; and
a payments module to effect the extra payment from the investment manager to the investor.

2. A computer system according to claim 1 wherein the investment is one or more of cash, bonds, stocks, property or an investment fund.

3. A computer system according to claim 1 wherein the monitoring module receives investment data via a communications network.

4. A computer system according to claim 1 wherein the monitoring module receives investment data from a third party investment management system.

5. A computer system according to claim 4 wherein the investment data is stored in a memory for use by the comparator module.

6. A computer system according to claim 1 wherein the booster module determines an extra payment from the investment manager to the investor in the event that the performance of the investment is not in the top quartile of all funds in its sector over a period of time from a commencement date.

7. A computer system according to claim 6 wherein the extra payment is a payment to the investor's investment fund based on the fund's relative performance in its sector.

8. A method for managing an investment on behalf of an investor, the method including:
Monitoring, by a computer, the performance of an investment over a period of time, the investment being an investment managed by an investment manager on behalf of an investor;
Comparing, by the computer, the performance of the investment with the performance of other similar types of investments for the period of time;
Determining, by the computer, an extra payment from the investment manager to the investor in the event that the performance of the investment is not as good as the performance of the other similar types of investments for the period of time; and
effecting the extra payment from the investment manager to the investor.

9. A method according to claim 8 wherein the investment is one or more of cash, bonds, stocks, property or an investment fund.

10. A method according to claim 8 wherein the monitoring includes receiving investment data via a communications network.

11. A method according to claim 10 wherein the investment data is received from a third party investment management system.

12. A method according to claim 11 wherein the investment data is stored in a memory for use by the comparator module.

13. A method according to claim 8 wherein an extra payment is made from the investment manager to the investor in the event that the performance of the investment is not in the top quartile of all funds in its sector over a period of time from a commencement date.

14. A method according to claim 13 wherein the extra payment is a payment to the investor's investment fund based on the fund's relative performance in its sector.
